(19) United States
(12) Patent Application Publication
(10) Pub. No.: US 2020/0133823 A1
(43) Pub. Date: Apr. 30, 2020

(54) IDENTIFYING KNOWN DEFECTS FROM GRAPH REPRESENTATIONS OF ERROR MESSAGES

(71) Applicant: CA, Inc., Islandia, NY (US)

(72) Inventors: Preetdeep Kumar, Hyderabad (IN); Subhadip Ghosh, Kolkata (IN)

(73) Assignee: CA, Inc., Islandia, NY (US)

(21) Appl. No.: 16/169,882

(22) Filed: Oct. 24, 2018

(51) Int. Cl. G06F 11/36; G06F 11/07; G06F 11/34

(52) U.S. Cl. CPC G06F 11/3624; G06F 11/3476; G06F 11/0787

(57) ABSTRACT

According to at least one embodiment, a known defect record, which includes a unique identifier for the known defect and one or more log files associated with the known defect, is accessed. A log file of the known defect record is accessed, and an error message is identified. The error message indicates one or more classes involved in producing the error and one or more methods associated with each class. A pattern object is generated based on the error message and the classes and methods indicated in the error message, and a known defect graph is updated based on the pattern object. The known defect graph includes vertices representing pattern objects for error messages identified in known defects of the defect management system, and edges representing relationships between the pattern objects, with each vertex indicating one or more defect identifiers for known defect records associated with the pattern object.

### BACKGROUND

The present disclosure relates in general to the field of computing systems, and more specifically, to creating graph representations of known defect patterns and using the graphs to identify known defects from log files.

Typically, new or updated software goes through some level of testing (e.g., a minimal acceptance test (MAT)) before being deployed in customer environments. In some cases, the software may fail or cause errors in the customer environment (e.g., after the customer runs a user acceptance test (UAT)). A log file may be created in response to the error, and the customer may in turn provide the log file to support personnel to assist in triaging the issue. However, the support personnel may not be familiar with the error and may not be able to locate any known defects in a defect management system based on the log file and may refer the log file to a developer for further assistance. The developer may realize that the error is caused by a known defect and may accordingly notify the support personnel of the known defect and a corresponding fix to the known defect. This process of identifying known defects can be quite inefficient, demanding support and development team time to identify the known defect.

### BRIEF SUMMARY

According to at least one embodiment, a known defect record in a defect management system is accessed. The known defect record includes a unique identifier for the known defect and one or more log files associated with the known defect. A log file of the known defect record is accessed, and an error message is identified in the log file. The error message indicates one or more classes involved in producing the error and one or more methods associated with each class. A pattern object is generated based on the error message and the classes and methods indicated in the error message, and a known defect graph is updated based on the pattern object. The known defect graph includes vertices representing pattern objects for error messages identified in known defects of the defect management system, and edges representing relationships between the pattern objects, with each vertex indicating one or more defect identifiers for known defect records associated with the pattern object.

According to another aspect of the present disclosure, an input log file that includes one or more error messages generated in response to execution of a computer program is received. An error message is identified in the input log file, with the error message indicating one or more classes involved in producing the error and one or more methods associated with each class. A pattern object is generated based on the error message, with the pattern object indicating relationships between the classes and methods indicated in the error message. It is determined whether a vertex of a known defect graph represents a match with the pattern object. The known defect graph includes a plurality of vertices representing respective pattern objects for error messages identified in known defects of a defect management system and edges representing relationships between the pattern objects. Based on a determination that a vertex of the known defect graph represents a match with the pattern object, one or more defect identifiers associated with the vertex are identified, with the defect identifiers uniquely identifying known defect records of the defect management system.

### BRIEF DESCRIPTION OF THE DRAWINGS

FIGS. 1A-1B are simplified diagrams of an example computing environment in accordance with at least one embodiment.

FIG. 2 is a diagram of an example known defect record of a defect management system in accordance with at least one embodiment.

FIG. 3 is a diagram of example pattern objects for error messages in log files of the known defect record of FIG. 2 in accordance with at least one embodiment.

FIG. 4 is a diagram of an example known defect graph representing the pattern objects of FIG. 3 in accordance with at least one embodiment.

FIGS. 5A-5B are diagrams of an example process of creating a graph representation of known defect patterns in accordance with at least one embodiment.

FIGS. 6A-6B are diagrams of an example process of using a graph representation of known defect patterns to identify known defects in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

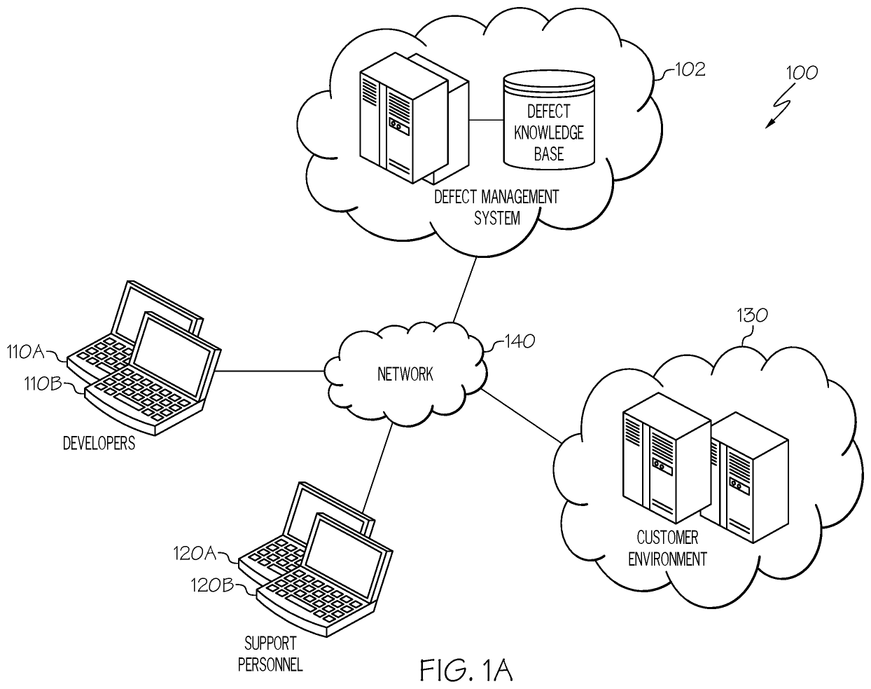

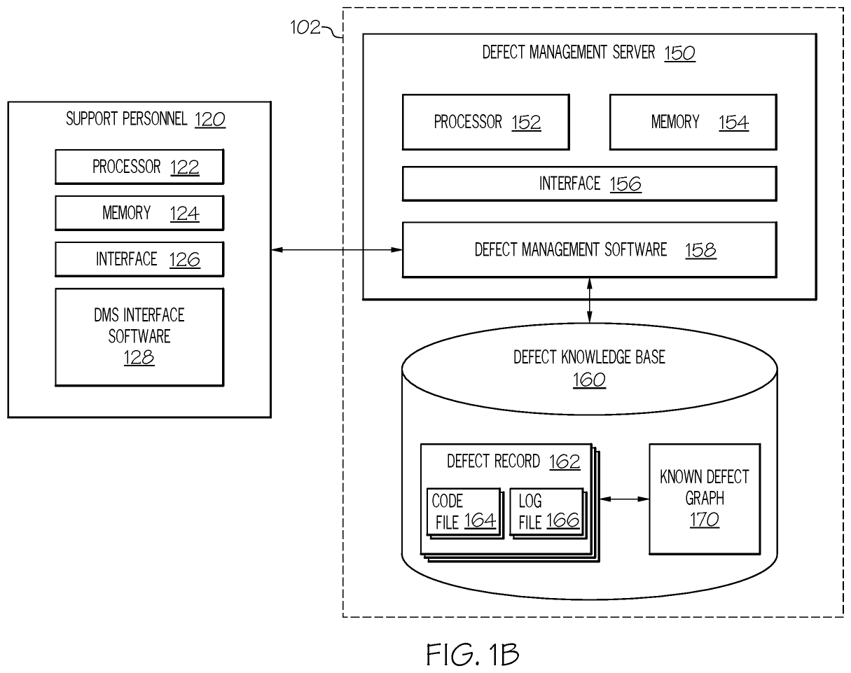

FIGS. 1A-1B are simplified diagrams of an example computing environment 100 in accordance with at least one embodiment. The computing environment 100 includes a defect management system 102 that manages (e.g., tracks) known defects using defect records, a developer 110 of the software, a support engineer 120 that provides support customers using the software, and a customer environment 130 in which the software is deployed. The defect management system 102 may include one or more servers (e.g., 150) attached to a defect knowledge base (e.g., 160), which may include a set of known defect records and a graph representation of error messages seen in the known defect records. The graph representation of the error messages may be created and used as described herein, such as, for example, to more efficiently identify known defects seen in log files sent by customers to the support personnel.

In some cases, the developer 110 may test and verify new or updated source code for the software before deploying the software the in the customer environment 130. However, once deployed in the customer environment 130, the new source code may cause unforeseen errors. One or more log files may be created in response to the errors, and the customer may provide the log files to the support personnel 120 so that the support personnel 120 may assist in triaging the issue. In typical situations, the support personnel 120 may be required to manually search through the defect knowledge base of the defect management system to determine whether the error is caused by a known defect in the software, which may be problematic if the developer 110 (who may have developed new code to fix the known issue) and the support personnel 120 use different language to describe the error. If no known defect is found during the manual search, the support personnel 120 may refer the log files to the developer 110 so that they may further assist. In some cases, the developer 110 may recognize the errors and refer the support personnel 120 to a known defect record in the defect management system 102. However, in some cases, the developer 110 may not be familiar with the source code and may attempt to fix the issue with new code. In either event, if the errors are caused by a known defect, unnecessary time is spent by both the developer 110 and the support personnel 120 to help address the issues seen in the customer environment 130.

Accordingly, in aspects of the present disclosure, a defect knowledge base may be created that allows support personnel 120 to more efficiently identify known defects. In some cases, this may help to reduce time spent by support personnel 120 or developers 110, or altogether avoid the need to spend valuable developer time in triaging issues seen in the customer environment 130. In addition, in some cases, the defect knowledge base may be useful in identifying and alerting developers to known defects introduced by new source code (sometimes referred to as “regression”). The defect knowledge base may include a graph representation of “patterns” seen in error messages generated during execution of the software, as described further below. The pattern” may be discovered from error messages in log files and may map to a deterministic set of errors and be specific to an environment. For example, the pattern of error1 followed by error2 will provide a better chance of identifying existing defects versus searching for error1 and error2 individually, which may result in a large number or results, most of which might not be of interest. As described further below, in some embodiments, change-sets and log files of defect records stored in a defect management system may be used to discover the relevant patterns. As also described further below, by using the assembled knowledge base, a developer may be alerted if a code change has introduced a regression, or support personnel may be provided with a list of known defects and corresponding software versions that fix the known defect based on a log file provided by a customer.

In the example shown in FIG. 1B, the defect management system 102 includes a defect management server 150, which processor 152, memory 154, and an interface 156, and a defect knowledge base 160 coupled to the defect management server 150. The example processor 152 executes instructions, for example, to perform one or more of the functions described herein. The instructions can include programs, codes, scripts, or other types of data stored in memory. Additionally, or alternatively, the instructions can be encoded as pre-programmed or re-programmable logic circuits, logic gates, or other types of hardware or firmware components. The processor 152 may be or include a general-purpose microprocessor, as a specialized co-processor or another type of data processing apparatus. In some cases, the processor 152 may be configured to execute or interpret software, scripts, programs, functions, executables, or other instructions stored in the memory 154. In some instances, the processor 152 includes multiple processors or data processing apparatuses.

The example memory 154 includes one or more computer-readable media. For example, the memory 154 may include a volatile memory device, a non-volatile memory device, or a combination thereof. The memory 154 can include one or more read-only memory devices, random-access memory devices, buffer memory devices, or a combination of these and other types of memory devices. The memory 154 may store instructions (e.g., programs, codes, scripts, or other types of executable instructions) that are executable by the processor 152.

The example interface 156 provides communication between the defect management server 150 and one or more other computing devices, such as a support personnel device 120, developer device 110, defect knowledge base 160 or another computing device. The interface 156 may include a wireless network interface or a wired network interface that provides communication between the defect management server 150 and the other computing devices (e.g., 110, 120) over the network 140. The interface 156 may include a WIFI interface, Bluetooth interface, or other type of wireless interface, or may include a Gigabit Ethernet interface or other type of wired interface for communicating over the network 140. The interface 156 may include another type of interface as well.

The support personnel device 120 shown in FIG. 1B includes a processor 122, memory 124, and interface 126. The processor 122 may be implemented similar to the processor 152 of the defect management server 150, the memory 124 may be implemented similar to the memory 154 of the defect management server 150, and the interface 126 may be implemented similar to the interface 156 of the defect management server 150. The device 120 runs defect management software (DMS) interface software 128 that allows the device 120 to interact with defect management software 158 of the defect management system 102 (running on the defect management server 150). For instance, the software 128 may allow the support personnel device 120 to provide (e.g., upload) a log file to the defect management server 150 so that the server may identify one or more known defects that may be related to the error messages seen in the log file provided, as described further herein.

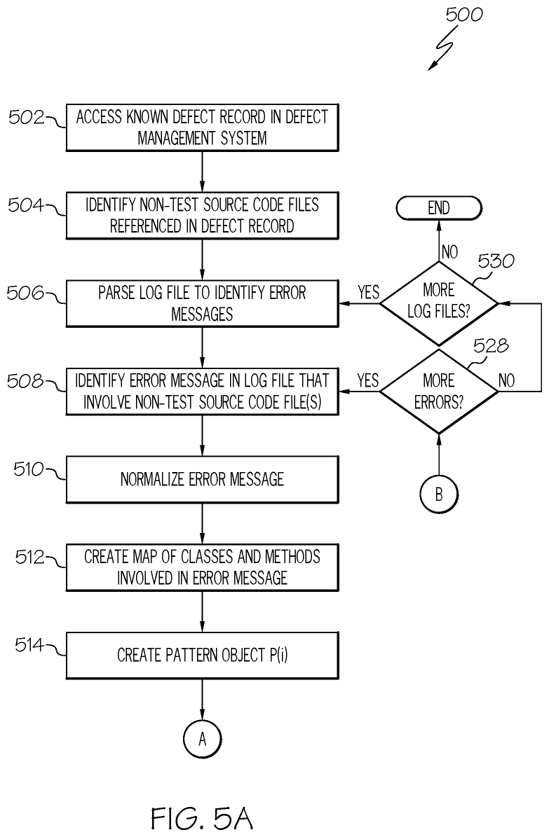

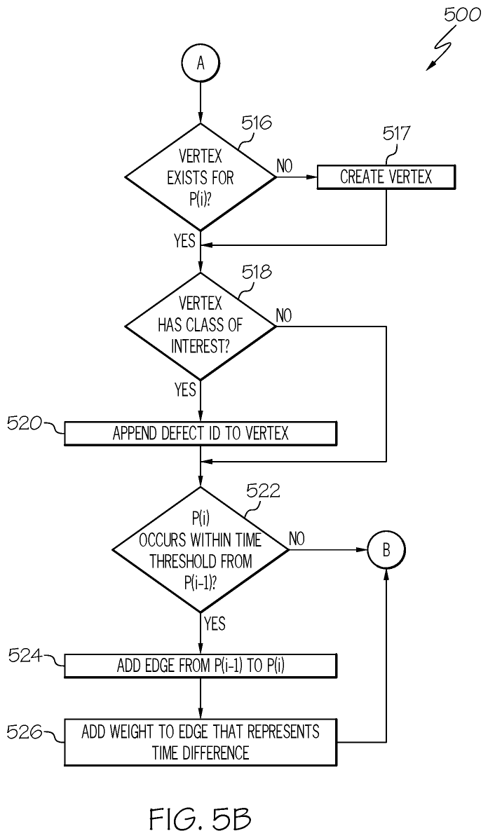

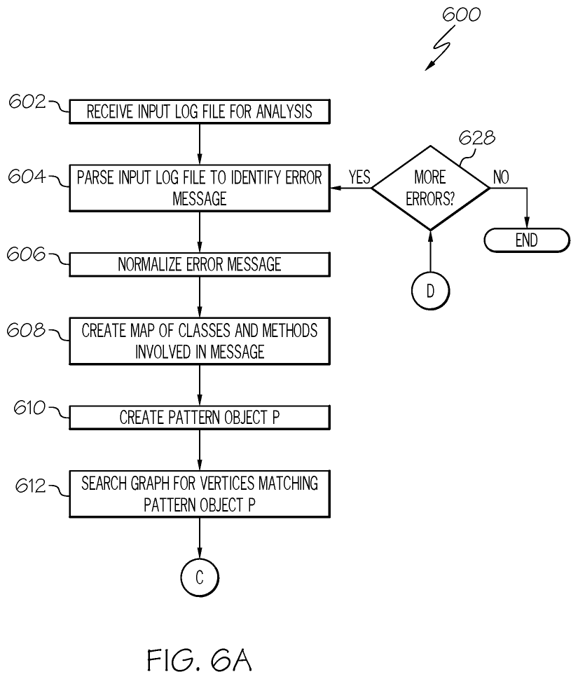

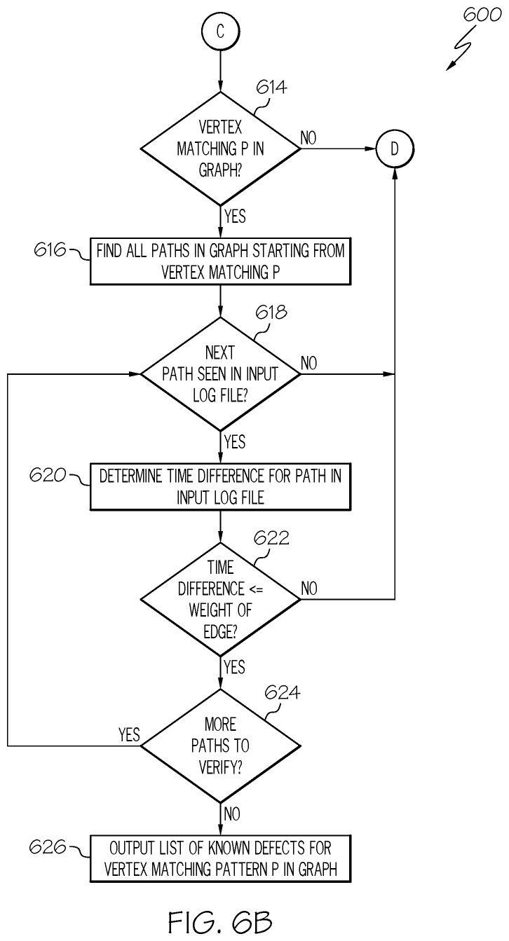

The defect management server 150 runs defect management software 158 for managing a defect knowledge base 160 of the defect management system 102 and interfacing with computing devices (e.g., through DMS software 128) outside of the defect management system 102, such as support personnel device 120. Some examples of defect management software 158 may include BUGZILLA™ and JIRA™. The defect management software 158 may execute on the processor 152 to perform one or more of the functions described herein. For example, the defect management software 158 may generate a known defect graph (e.g., 170) from a set of known defect records (e.g., 162) in the defect knowledge base 160, and may perform one or more of the operations of FIGS. 5A-5B to do so. As another example, the defect management software 158 may query a known defect graph (e.g., 170) to identify a set of known defects that may be related to error messages in a log file provided by the device 120, and may perform one or more of the operations of FIGS. 6A-6B to do so.

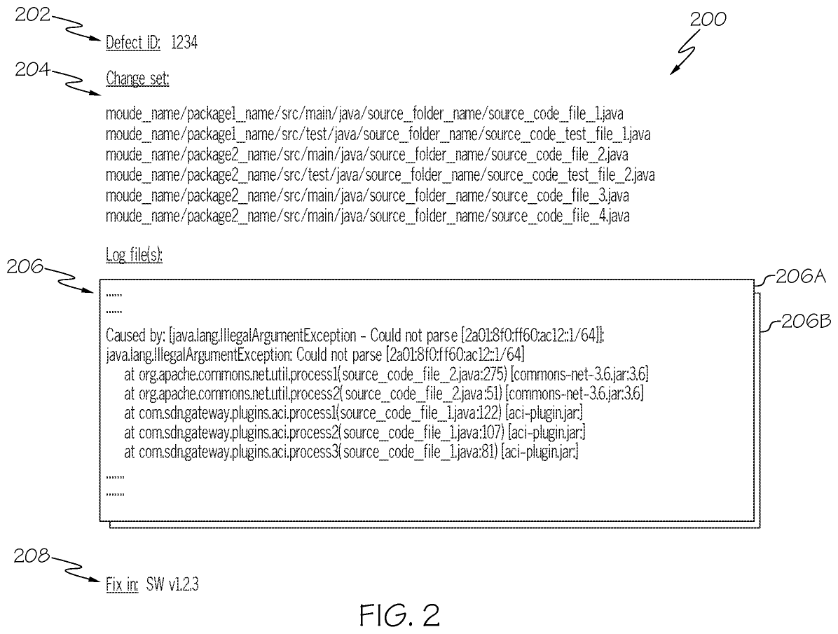

The defect knowledge base 160 stores a number of defect records 162 for known or otherwise identified defects associated with one or more software applications. The defect records 162 may be used to track and manage different errors identified during execution of the software applications. Each defect record 162 may include one or more log files 166 associated with or generated in response to the errors seen during execution of the software, and one or more code files 164 generated by developers (e.g., 110) to fix the defect associated with the defect record 162. An example defect record is shown in FIG. 2 and described further below.

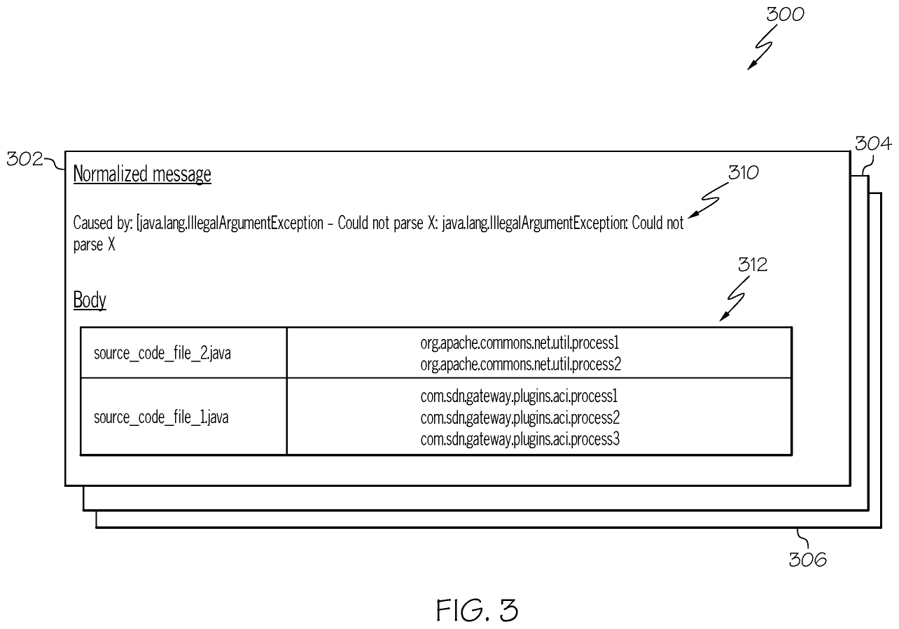

The defect knowledge base 160 may also include a known defect graph 170 that is a graph representation of errors seen in the defect records 162. The known defect graph 170 may be constructed as described herein based on error messages identified in the log files 166 of the defect records 162. For example, the vertices of the known defect graph 170 may represent error patterns identified in the log files 166 of the defect records 162 and edges of the known defect graph 170 may represent relationships between the patterns, as described further below. An example graph representation of patterns is shown in FIG. 3 and described further below. The known defect graph 170 may be used in some instances (e.g., by a developer 110 or support personnel 120) to identify known defects in a piece of software based on log files generated in response to execution of the software, as described further below.

In general, “servers,” “clients,” “computing devices,” “network elements,” “database systems,” “user devices,” and “systems,” etc. in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, zOS, etc., as well as virtual machines and emulators adapted to virtualize execution of a particular operating system, as well as container-based operating environments (e.g., Docker containers, Kubernetes containers, etc.), and customized and proprietary operating systems among other examples.

Further, servers, clients, network elements, systems, and computing devices can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. In some instances, a server, system, subsystem, or computing device can be implemented as some combination of devices that can be hosted on a common computing system, server, server pool, or cloud computing environment and share computing resources, including shared memory, processors, and interfaces.

FIG. 2 is a diagram of an example known defect record 200 of a defect management system in accordance with at least one embodiment. The known defect record 200 represents a known or otherwise identified defect, or “bug”, of a software application. The known defect record 200 may be maintained in a defect management system, such as the defect management system 102 of FIGS. 1A-1B (e.g., defect records 162). The known defect record 200 may include additional, fewer, or different components than those shown in FIG. 2, or may be formatted in another manner.

In the example shown, the known defect record 200 includes a defect identifier 202 to uniquely identify the defect, a change set 204 indicating source code files that include changes to fix the defect, log files 206 generated by the defect, and an indication 208 of a software version that fixes the known defect represented by the record 200. The example defect identifier 202 is a number that uniquely identifies the record, but in some cases, may be formatted in another manner, such as a string of alphanumeric characters.

The change set 204 includes a list of source code files and their associated file paths that were modified by a developer or developers during a debugging process to fix the defect. In some cases, such as the example shown in FIG. 2, the change set 204 may include “test” files that are non-implemented (e.g., non-production) source code files along with the “non-test” files source code files that were implemented in the software version indicated by the indicator 208 to fix the defect. The test files may be identified, in some implementations, by the word “test” being in the filepath or the filename. For instance, referring to the example shown in FIG. 2, the second and fourth files listed in the change set 204 having “moude_name/packageX_name/src/test . . . ” as a filepath prefix (and including “test” in the filenames are test files), while the first and third files listed in the change set 204 are non-test files since they do not include the word “test” in either their filepath prefix or filename.

Each known defect record may include one or more log files 206, which may each include an output of a component of the software application produced in response to the defect occurring during execution of the software. The log files 206 may include one or more error messages that indicate an exception during the execution of the software, and one or more parameters for each error message. The log files 206 may also indicate one or more source code files that were involved in the generation of the exception. For instance, the error message shown in log file 206A (“Caused by: [java.lang.IllegalArgumentException—Could not parse [2a01:8f0:ff60:ac12::1/64]]: java.lang.IllegalArgumentException: Could not parse [2a01:8f0:ff60:ac12::1/64]”, where “2a01:8f0:ff60:ac12::1/64” is the parameter) indicates that the source code files “source_code_file_2.java” and “source_code_file_1.java” were involved in producing the error message. The log files 206 may also include a timestamp or other indication of a time at which error messages were generated.

In some embodiments of the present disclosure, components of the defect record 200 may be used to create a pattern object for the error messages in the log files 206, which may in turn be used to generate or update a graph representation of errors caused by known defects in the software application.

FIG. 3 is a diagram of example pattern objects 300 for error messages in log files of the known defect record of FIG. 2 in accordance with at least one embodiment. In the example shown, the pattern object 302 is associated with the log file 206A of FIG. 2, while pattern objects 304, 306 may be associated with the log file 206B of FIG. 2 (where the log file 206B includes multiple error messages). The pattern objects may include additional, fewer, or different information than that shown in FIG. 3, or may be formatted in another manner.

The example pattern objects 300 include an error message 310 and a map 312 of classes and associated methods involved in producing the error message 310. In the example shown, the error message 310 has been normalized so that it may be more accurately compared with other error messages. Normalizing the error message may include replacing the parameter of the error message with a fixed string. For instance, in the example shown, the parameter of the error message 310 (“2a01:8f0:ff60:ac12::1/64”) has been replaced with an “X”. As described above, the error message in the log file 206A involved source code files (or classes) “source_code_file_2.java” and “source_code_file_1.java”. The map 312 accordingly includes those classes as the objects in the left column of the table, and their respective associated methods in the right column of the table. In some cases, all stack traces in a log file may be considered before any occurrence of files/classes of interest, and subsequent errors in the log file may be ignored since they might be a symptom of the root cause stack trace. Further, in some cases, preceding traces may be root causes or might have led to the root cause, and therefore should be considered.

The example pattern object 302 may be created from the log file 206A of FIG. 2 according to the following example process. First, a defect management system storing the log file(s) may be scanned and a set of defect records may be accessed. In some instances, the set of defect records may be chosen based on a time range provided as input. For instance, a user may specify that only defect records from the past month or year should be accessed. Next, for each defect record, the non-test source code file names may be identified in the change set of the record and a list of classes or files of interest may be generated (e.g., class_of_interest=[source_code_file_1, source_code_file_2]). Then, each log file attached to or included in the defect record may be parsed to identify an error message (e.g., 310) or stack trace that involves one of the classes of interest. The message may then be normalized by masking the parameters of the error message with a fixed string/constant symbol (e.g., “X” or “$”). From the error message/stack trace, a map (e.g., 312) whose key is the class name and whose value is the list of method names may be created. Finally, the pattern object (e.g., 302) may be created by encapsulating the normalized error message (e.g., 310) and the map (e.g., 312).

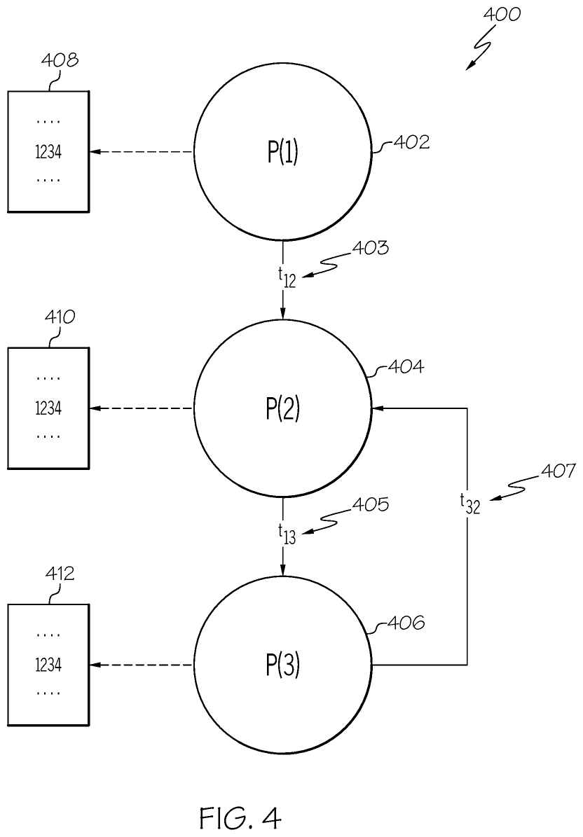

Additional error messages in the log files 206 may generate additional pattern objects 304, 306. The pattern objects generated from the log files 206 may then be used to generate a graph representation of the error messages. For instance, referring to FIG. 4, the vertices 402, 404, 406 may represent the pattern objects 302, 304, 306, respectively. Each vertex of the graph may include, as values, defect identifiers (e.g., 202) indicating one or more defects that are associated with the error message/pattern object. In some embodiments, each vertex of the graph may be generated from a pattern object by the following process. First, the graph may be searched to determine whether the pattern object is already present (i.e., represented by a vertex). If not, then a new vertex may be added. If the vertex indicates a class of interest (e.g., from the class_of_interest list above), then the defect identifier associated with the pattern object may be appended to the value list of the vertex. This may ensure that related defects or defects whose pattern are similar are captured. Finally, if the time difference between the error message/pattern object (P(i)) and an immediately preceding error message/pattern object (P(i−1)) is less than a threshold value, then an edge may be created between the two vertices representing the pattern objects. The threshold value may be specified or configured by a developer or other user. The weight of the edge may indicate the time difference between the occurrences of the error messages.

FIG. 4 is a diagram of an example known defect graph 400 representing the pattern objects of FIG. 3 in accordance with at least one embodiment. The graph representation 400 includes vertices 402, 404, 406 which are each connected by edges 403, 405, 407 as shown. Each vertex includes a value list (e.g., 408, 410, 412) that lists known defect identifiers associated with the pattern object that the vertex represents. The edges of the graph 400 may be generated between their corresponding vertices of the graph 400 based on a determination that a time difference between error message occurrences is within a particular time threshold (e.g., as described above). In some embodiments, the weight of the edges 403, 405, 407 may be the time difference between the occurrence of each error message represented by vertices 402, 404, 406. For example, the weight of edge 403 (t₁₂), may be the time difference between a timestamp of a first error message associated with the vertex 402 and a timestamp of a second error message associated with the vertex 404 (t₁₂=t_{P(2)}−t_{P(1)}). In the example shown, the vertices 402, 404, 406 represent the pattern objects 302, 304, 306 of FIG. 3, respectively.

FIGS. 5A-5B are diagrams of an example process 500 of creating a graph representation of known defect patterns in accordance with at least one embodiment. The process 500 may be performed for each known defect record of a defect management system. Operations in the example process 500 may be performed by components of a defect management system (e.g., the processor 152 or other components of the defect management server 150 of FIG. 1B). The example process 500 may include additional or different operations, and the operations may be performed in the order shown or in another order. In some cases, one or more of the operations shown in FIG. 5 are implemented as processes that include multiple operations, sub-processes, or other types of routines. In some cases, operations can be combined, performed in another order, performed in parallel, iterated, or otherwise repeated or performed another manner.

At 502, a known defect record of a defect management system is accessed. The known defect record may be a record maintained in a defect management system that tracks defects (sometimes referred to as “bugs”) that have been identified for a particular software application. As an example, the defect management system may be implemented similar to the defect management system 102 of FIGS. 1A-1B. The known defect record may include a set of information about an identified defect in the software. In some cases, for instance, the known defect record includes an identifier that unique identifies the known defect for the software, a change set that includes a list of source code files (which may include both test and non-test files) for the software that were modified to fix the defect, a set of log files (which may include a number of error messages or stack traces) generated in response to the defect occurring, and an identifier of a software version that fixes the known defect. For example, the known defect record may be formatted similar to the known defect record 200 of FIG. 2.

At 504, the non-test source code files referenced in the known defect record (e.g., in a change set as described above) are identified. The non-test source code files may be identified, in some embodiments, based on whether they include the string “test” in their filepath or filename. In some embodiments, the source code files identified at 504 may be referred to as “classes of interest” and an array of the classes of interest may be constructed (e.g., class_of_interest=[source_code_file_1, source_code_file_2]).

At 506, a first log file (or next log file, if the first log file has been fully analyzed as described below) of the known defect record is parsed to identify error messages, which may include stack traces in some instances. Parsing the log file may include identifying strings in the log file that are associated with error messages (e.g., “exception” or “could not parse”), or searching for known error messages for the relevant source code language.

At 508, an error message that involves one of the non-test source code files identified at 504 is identified in the log file. This may involve determining whether one of the classes of interest identified at 504 is referenced or called out as a class that generated the exception or error. For instance, referring to the example shown in the log file 206A of FIG. 2, it may be determined that the class “source_code_file_1.java” is referenced for multiple methods (e.g., com.sdn.gateway.plugins.aci.processX( )) as being involved in generating the exception/error message, since the class “source_code_file_1.java” is a non-test class referenced in the change set 204 (as described above).

At 510 the error message identified at 508 is normalized. This may include replacing the parameter(s) of the error message with a fixed character (e.g., “X” or “$”). Normalizing the error messages identified at 508 may allow the error messages to be compared across different log files, since various error messages may reference different parameters but still be associated with the same defect.

At 512, a map of the classes and methods involved in the error message is created. The map may list the classes involved in generating the error message and may reference, for each class, the one or more methods that correspond with the class. In some embodiments, the map may be formatted as a table or other type of relational data structure. For example, the map may be formatted similar to the map 312 of FIG. 3 in some embodiments.

At 514, a pattern object P(i) that represents the error message is created. The pattern object may include the normalized error message itself and the map generated at 510. For example, in some cases, the pattern object may be formatted similar to the pattern object 302 of FIG. 3.

At 516, is it determined whether a vertex in a graph already exists for the pattern object P(i) created at 514. If it is determined at 516 that a vertex corresponding to the pattern object P(i) does not yet exist in the graph, a new vertex is created at 517. In some cases, the new vertex may be created with an empty value list (which is to indicate associated defect identifiers for the vertex). In other cases, the identifier for the defect record may be immediately entered into the value list. If, however, it is determined at 516 that a vertex already exists in the graph (either because it was previously created, or was created at 517 with an empty value list), it is determined at 518 whether the vertex indicates a class of interest identified at 504. If it is determined that the vertex indicates a class of interest, then an identifier of the defect record accessed at 502 is appended to the value list for the vertex of the graph at 520 to associate the know defect with the vertex.

At 522, it is determined whether the pattern object P(i) occurs within a time threshold from a previous pattern object P(i−1). That is, it is determined whether the time difference between the occurrence or generation of the respective error messages associated with P(i) and P(i−1) is less than a threshold value. If the error messages were generated within the time threshold, an edge is added in the graph between the vertices representing P(i−1) and P(i) at 524, and a weight representing the time difference between the error messages corresponding to P(i) and P(i−1) is added to the edge at 526.

At 528, if the P(i) did not occur within the time threshold of P(i−1), or if an edge was added between P(i) and P(i−1) at 524, then it is determined whether there are additional error messages in the log file. If so, the process returns to 508 where the next error message involving a class of interest is identified (and subsequent operations are accordingly performed for the error message). If there are no additional errors in the log file, then it is determined at 530 whether there are any more log files in the defect record. If so, the process returns to 506, where the next log file is parsed (and subsequent operations are accordingly performed for the log file). Otherwise, the process 500 ends for the current known defect record that was accessed at 502, and the process 500 begins again for the next known defect record in the defect management record.

FIGS. 6A-6B are diagrams of an example process 600 of using a graph representation of known defect patterns to identify known defects in accordance with at least one embodiment. Operations in the example process 600 may be performed by components of a defect management system (e.g., the processor 152 or other components of the defect management server 150 of FIG. 1B). The example process 600 may include additional or different operations, and the operations may be performed in the order shown or in another order. In some cases, one or more of the operations shown in FIG. 6 are implemented as processes that include multiple operations, sub-processes, or other types of routines. In some cases, operations can be combined, performed in another order, performed in parallel, iterated, or otherwise repeated or performed another manner.

At 602, an input log file is received for analysis. The input log file may be received at a defect management system through an interface (e.g., web interface) that allows users (e.g., developers or support personnel) to provide log files to the defect management system to determine whether a particular error is related to a known defect. For example, in some cases, a developer may execute a simulation of new source code for an application, and the execution may generate a number of exceptions that are captured in one or more log files. Rather than manually search through the known defect records of the defect management system, the developer may provide the log file to the defect management system so that it may automatically determine whether the errors in the log file are being caused by a known defect (i.e., a regression). As another example, a customer may provide one or more log files to support personnel to diagnose an issue seen in the customer environment, and, rather than having the support personnel manually search the known defect records or involve developers, the support personnel may similarly provide the log files to the defect management system to determine whether the errors seen in the customer environment are related to a known defect (and thus, whether there is known fix to the issue).

At 604, the input log file is parsed to identify an error message. Parsing the log file for the error messages may be done in a similar manner to that described above with respect to operations 506 and 508 of FIG. 5.

At 606, the error message is normalized. Normalizing the error message may be done in a similar manner to that described above with respect to operation 510 of FIG. 5. For example, normalizing the error message may include replacing parameters of the error message identified at 604 with a fixed character (e.g., “X” or “$”).

At 608, a map of the classes and methods involved in the error message identified at 604 is created. The map may be generated in a similar manner to that described above with respect to operation 512 of FIG. 5.

At 610, a pattern object P is created. The pattern object may be created in a similar manner to that described above with respect to operation 514 of FIG. 5. For example, the pattern object P may include the normalized error message and may indicate relationships between the classes and methods involved in the error message.

At 612, a known defect graph (e.g., a graph created by the process 500) is searched for vertices matching the pattern object P created at 610, and at 614, it is determined whether a vertex matching the pattern object P is in the known defect graph. If it is determined at 614 that a vertex match exists for the pattern object P, then all paths (edges) between vertices in the known defect graph starting from the vertex matching P are found at 616. For instance, referring to the example shown in FIG. 4, if the pattern object P matches P(1) (vertex 402), then the edges 403, 405, 407 will all be identified at 616. Likewise, if the pattern object P matches P(2) (vertex 404), then the edges 405, 407 will be identified at 616, and if the pattern object P matches P(3) (vertex 406), then the edge 407 will be identified at 616.

At 618 and it is determined whether the first path found at 616 exists in the input log file received at 602. That is, it is determined whether a subsequent error message exists in the input log file whose corresponding pattern object matches the next vertex in the path. For instance, referring again to the example shown in FIG. 4, if the pattern object P matches P(1) (vertex 402), then it will be determined at 618 whether the log file has a subsequent error message whose corresponding pattern object matches P(2) (vertex 404).

If it is determined at 618 that the path is found in the input log file, the time difference for the path is determined at 620. Using the previous example for FIG. 4 for illustration, determining the time difference may include determining a time difference between the error messages of the input log file that correspond to the pattern objects P(1) and P(2) based on timestamps for the respective error messages in the input log file.

At 622, it is determined whether the time difference determined at 618 is less than or equal to the weight of the edge in the known defect graph. Using the same example for FIG. 4 for illustration, this may include determining whether the time difference between P(1) and P(2) is less than or equal to the time t₁₂. If it is determined at 622 that the time difference in the input log file is less than or equal to the time difference indicated by the edge weight, then it is determined at 624 whether there are additional paths in the known defect graph to verify against the input log file. If so, the operations 618-622 are repeated for the next path. If there are no additional paths to verify, then a list of known defects for the vertex (e.g., the identifiers stored in the value list of the vertex, similar to the lists 408, 410, 412 of FIG. 4) matching the pattern object P are provided as output. The list of known defects may be provided as a suggestion to the user who provided the input log file that the error messages in the input log file may be caused by or somehow related to the known defects. In this manner, the user may be able to more quickly identify a set of known defect records to look at for further analysis (as opposed to manually searching, as described above).

However, if it is determined at 614 that there is no vertex matching the pattern object P in the known defect graph, determined at 618 that a path found in the known defect graph is not also in the input log file, or determined at 622 that the time difference determined at 620 is greater than the weight of the edge in the known defect graph, then it is determined at 628 whether there are additional error messages in the input log file to analyze. If there are additional error messages, then the operations of the process 600 starting at 604 are repeated for the next error message in the input log file. If there are no additional error message to analyze in the input log file, then the process 600 ends without suggesting any known defects for the input log file.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
accessing a known defect record in a defect management system, the known defect record comprising a unique identifier for the known defect and one or more log files associated with the known defect;
accessing a log file of the known defect record;
identifying an error message in the log file, the error message indicating one or more classes involved in producing the error and one or more methods associated with each class;
generating a pattern object based on the error message and the classes and methods indicated in the error message; and
updating a known defect graph based on the pattern object, the known defect graph comprising vertices representing pattern objects for error messages identified in known defects of the defect management system and edges representing relationships between the pattern objects, wherein each vertex indicates one or more defect identifiers for known defect records associated with the pattern object.

2. The method of claim 1, wherein the known defect record comprises a change set indicating one or more code files whose code was modified to address the known defect, and accessing the log file comprises:
identifying one or more code files of interest of the change set; and
determining that the log file references at least one of the code files of interest;

3. The method of claim 2, wherein identifying the one or more code files of interest comprises identifying non-test code files in the change set of the known defect record.

4. The method of claim 1, further comprising normalizing the identified error message by replacing a parameter of the error message with a fixed character.

5. The method of claim 1, wherein the pattern object comprises the error message, and indicates relationships between the classes and methods indicated in the error message.

6. The method of claim 1, wherein updating the known defect graph comprises:
determining that the known defect graph includes a vertex representing the pattern object; and
modifying the vertex to indicate the defect identifier for the known defect record associated with the pattern object based on the determination.

7. The method of claim 1, wherein updating the known defect graph comprises:
determining that the known defect graph does not include a vertex for the pattern object; and
creating a new vertex in the known defect graph that represents the pattern object based on the determination.

8. The method of claim 1, wherein updating the known defect graph comprises:
determining a time difference between the error message associated with the pattern object and an error message associated with a preceding pattern object; and
creating an edge between the pattern object and the preceding pattern object based on a determination that the time difference is below a threshold value.

9. The method of claim 8, wherein a weight of the edge indicates the time difference.

10. The method of claim 1, further comprising:
receiving an input log file; and
generating a new pattern object for an error message of the input log file;
determining that the known defect graph includes a vertex representing a pattern object matching the new pattern object; and
identifying a list of unique identifiers for known defect records in the defect management system that are associated with the vertex.

11. A non-transitory computer readable medium having program instructions stored therein, wherein the program instructions are executable by a computer system to perform operations comprising:
accessing a set of known defect records in a defect management system, each known defect record comprising a unique identifier for the known defect, a change set indicating one or more code files whose code was modified to address the known defect, and one or more log files associated with the known defect; and
for each known defect record:
identifying one or more code files of interest from the change set for the known defect record;
identifying one or more log files of the known defect record that include error messages indicating at least one code file of interest; and
for each error message in the identified log files:
constructing a pattern object for the error message, the pattern object indicating relationships between the classes and their associated methods indicated in the error message; and
updating a known defect graph based on the pattern object, the known defect graph comprising vertices representing pattern objects for error messages identified in known defects of the defect management system and edges representing relationships between the pattern objects, wherein each vertex indicates one or more defect identifiers for known defect records associated with the pattern object.

12. The non-transitory computer readable medium of claim 11, wherein identifying the one or more code files of interest comprises identifying non-test code files in the change set for the known defect record.

13. The non-transitory computer readable medium of claim 11, wherein constructing a pattern object for the error message comprises normalizing the error message by replacing a parameter of the error message with a fixed character.

14. The non-transitory computer readable medium of claim 11, wherein updating the known defect graph comprises:
determining that the known defect graph includes a vertex representing the pattern object; and
modifying the vertex to indicate the defect identifier for the known defect record associated with the pattern object based on the determination.

15. The non-transitory computer readable medium of claim 11, wherein updating the known defect graph comprises:
determining that the known defect graph does not include a vertex for the pattern object; and
creating a new vertex in the known defect graph that represents the pattern object based on the determination.

16. The non-transitory computer readable medium of claim 11, wherein updating the known defect graph comprises:
determining a time difference between the error message associated with the pattern object and an error message associated with a preceding pattern object; and
creating an edge between the pattern object and the preceding pattern object based on a determination that the time difference is below a threshold value.

17. The non-transitory computer readable medium of claim 11, wherein the operations further comprise:
receiving an input log file comprising an error message; and
generating a new pattern object for the error message of the input log file;
determining that the known defect graph includes a vertex representing a pattern object matching the new pattern object; and
identifying a list of unique identifiers for known defect records in the defect management system that are associated with the vertex.

18. A system comprising:
a data processing apparatus;
a memory; and
a known defect identifier engine, executable by the data processing apparatus to:
receive an input log file, the input log file comprising one or more error messages generated in response to execution of a computer program;
identify an error message in the input log file, the error message indicating one or more classes involved in producing the error and one or more methods associated with each class;
generate a pattern object based on the error message, the pattern object indicating relationships between the classes and methods indicated in the error message;
determine whether a vertex of a known defect graph represents a match with the pattern object, wherein the known defect graph comprising a plurality of vertices representing respective pattern objects for error messages identified in known defects of a defect management system and edges representing relationships between the pattern objects; and
identify, based on a determination that a vertex of the known defect graph represents a match with the pattern object, one or more defect identifiers associated with the vertex, the defect identifiers uniquely identifying known defect records of the defect management system.

19. The system of claim 18, wherein the error message is a first error message, the pattern object is a first pattern object, and the known defect identifier engine is further to:
identify a second error message in the input log file;
generate a pattern object based on the second error message, the second pattern object indicating relationships between classes and methods indicated in the second error message; and
determine whether an edge exists in the known defect graph between the vertex representing a match with the first pattern object and a vertex representing a match with the second pattern object;
wherein identifying the one or more defect identifiers is further based on a determination that an edge exists in the known defect graph between the vertex representing a match with the first pattern object and a vertex representing a match with the second pattern object.

20. The system of claim 19, wherein the known defect identifier engine is further to determine a time difference between the first and second error messages, and identifying the one or more defect identifiers is further based on a determination that the time difference is less than a weight of the edge between the vertex representing a match with the first pattern object and a vertex representing a match with the second pattern object.
